(19) United States
(12) Patent Application Publication
(10) Pub. No.: US 2004/0059573 A1
(43) Pub. Date: Mar. 25, 2004

(54) Voice command identifier for a voice recognition system

(76) Inventor: Hwajin Cheong, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/644,886

(22) Filed: Aug. 19, 2003

Related U.S. Application Data
(63) Continuation of application No. PCT/KR02/00268, filed on Feb. 20, 2002.

(51) Int. Cl. G10L 15/00

(52) U.S. Cl. 704/249

(57) ABSTRACT

A voice command identifier for a voice recognition system is disclosed. In one aspect of the invention, the voice command identifier can selectively identify and recognize a user voice command received along with the background sound generated from the speaker of a device being controlled.

### RELATED APPLICATIONS

This application is a continuation application, and claims the benefit under 35 U.S.C. §§120 and 365 of PCT application No. PCT/KR02/00268 filed on Feb. 20, 2002 and published on Sep. 26, 2002, in English, which is hereby incorporated by reference herein.

### BACKGROUND OF THE INVENTION

1. Field of the Invention

The present invention relates to a voice command identifier for a voice recognition system, especially to a voice command identifier for recognizing a valid voice command of a user by identifying user's voice command from a sound output from an embedded sound source.

2. Description of the Related Technology

It is generally known that a conventional voice recognition system can recognize a voice command spoken by a human effectively through a various kinds of methods (Detailed descriptions on the conventional recognizing methods or structures of the conventional voice recognition systems are already known in the art of the present invention, and are not direct subject matters of the present invention, so that they are omitted for simplicity.).

However, as shown in FIG. 1, a conventional home appliance 10, such as televisions, audio players or video players, which can produce a sound output, can not distinguish user's voice command from input sound, which was output by its own embedded sound source and re-input into itself by reflection and/or diffraction. Therefore, it is impossible to use the conventional voice recognition system for an apparatus with a sound source because the voice recognition system can not distinguish a voice command from a re-input sound.

A conventional approach for solving this problem eliminates a re-input sound from a received signal of a microphone 104 by estimating output sound with time. Let the received signal of the microphone 104 be S_{mic}(t), and the sound signal output by a speaker 102 be S_{org}(t). Then, the received signal of the microphone 104 S_{mic}(t) includes a voice command signal S_{command}(t) of a voice command spoken by a user and a distortion signal S_{dis}(t) which is a distorted signal of the sound signal S_{org}(t) by reflection and/or diffraction in its way to the microphone 104 from the speaker 102. This is expressed by Equation 1, as follows:

$$\begin{matrix}{S}_{mic} ( t ) = {S}_{command} ( t ) + {S}_{dis} ( t ) \\ = {S}_{command} ( t ) + {\sum }_{k = 0}^{N} ( {A}_{k} \times {S}_{org} ( t - {t}_{k} ) )\end{matrix} \qquad [ Equation 1 ]$$

Here, tₖ is a delay time due to reflection and has a value of reflection distance divided by the velocity of sound. Aₖ (“environmental variable”) is a variable influenced by its environment and determined by the amount of energy loss of the output sound due to the reflection. Since output sound S_{org}(t) is already known, it was asserted to be possible to extract user's voice command only by determining values of Aₖ and tₖ. However, it is very difficult to embody a hardware or a software system which can perform the direct calculations of the above Equation 1 in real time since the amount of calculation is too big.

There was another approach to decrease the amount of calculation by transforming the distortion signal S_{dis}(t) with, for example, Fourier Transformation. But, it is required to know all environmental variables according to its real operating environment in advance, which is impossible.

### SUMMARY OF CERTAIN INVENTIVE ASPECTS OF THE INVENTION

One aspect of the invention provides a voice command identifier which can perform the required calculation by decreasing the amount of calculations by acquiring and storing environmental variables on initial installation.

Another aspect of the invention provides a voice command identifier which is adaptive to change of environment by acquiring and renewing environmental variables when the system is placed under a new environment.

Another aspect of the invention provides a voice command identifier for a voice-producible system having an internal circuitry performing a predetermined function, an audio signal generator for generating a sound signal of audio frequency based on a signal provided from the internal circuitry, a speaker for outputting the sound signal as an audible sound, a microphone for receiving external sound and converting them into an electrical signal and a voice recognizer for recognizing an object signal included in the electrical signal from the microphone, including: a memory of a predetermined storing capacity; a microprocessor for managing the memory and generating at least one control signal; a first analog-to-digital converter for receiving the sound signal from the audio signal generator and converting them into a digital signal in response to control of the microprocessor; an adder for receiving the electrical signal from the microphone and outputting the object signal, which is to be recognized by the voice recognizer in response to control of the microprocessor; a second analog-to-digital converter for receiving the object signal and converting them into a digital signal; a first and second digital-to-analog converters for respectively converting retrieved data from the memory into analog signals in responsive to control of the microprocessor; and an output selecting switch for selecting one of outputs out of the second digital-to-analog converter and the audio signal generator in responsive to control of the microprocessor.

Another aspect of the invention provides a voice command identifying method for a voice-producible system having an internal circuitry performing a predetermined function, an audio signal generator for generating a sound signal of audio frequency based on a signal provided from the internal circuitry, a speaker for outputting the sound signal as an audible sound, a microphone for receiving external sound and converting them into an electrical signal and a voice recognizer for recognizing an object signal comprised in the electrical signal from the microphone, the method comprising: (1) determining whether a setting operation or a normal operation is to be performed; in case the determination result of the step (1) shows that the setting operation is to be performed, (1-1) outputting a pulse of a predetermined amplitude and width; and (1-2) acquiring an environmental coefficient uniquely determined by installed environment by digitizing a signal input into the microphone for a predetermined time period after the pulse is output; in case the determination result of the step (1) shows that the normal operation is to be performed, (2-1) acquiring a digital signal by analog-to-digital converting a signal output from the audio signal generator; (2-2) multiplying the digital signal acquired by the step (2-1) with the environmental coefficient and accumulating a multiplied result; and (2-3) digital-to-analog converting an accumulated result into an analog signal and generating the object signal by subtracting the analog signal from the electrical signal output from the microphone.

### BRIEF DESCRIPTION OF THE DRAWINGS

FIG. 1 shows a schematic diagram of a space where a home appliance including a voice command identifier according to an embodiment of the present invention.

FIG. 2 shows a voice recognition system including a voice command identifier according to an embodiment of the present invention.

FIG. 3 shows a schematic diagram of a memory structure managed by the voice command identifier shown in FIG. 2.

FIG. 4 shows a flowchart of operation of the voice command identifier shown in FIG. 2 according to an embodiment of the present invention.

FIG. 5 shows a flowchart of a “setting operation” shown in FIG. 4 according to an embodiment of the present invention.

FIG. 6 shows a flowchart of a “normal operation” shown in FIG. 4 according to an embodiment of the present invention.

FIG. 7 shows waveforms of a test signal output during the normal operation shown in FIG. 6 and a received signal resulted from the test signal.

FIG. 8 shows waveforms of a sound signal output during the normal operation shown in FIG. 6 and a received signal resulted from the sound signal.

FIG. 9 shows a waveform of an output signal output during the normal operation shown in FIG. 6.

### DETAILED DESCRIPTION OF CERTAIN EMBODIMENTS OF THE INVENTION

Now, a voice command identifier according to embodiments of the present invention is described in detail with reference to the accompanying drawings.

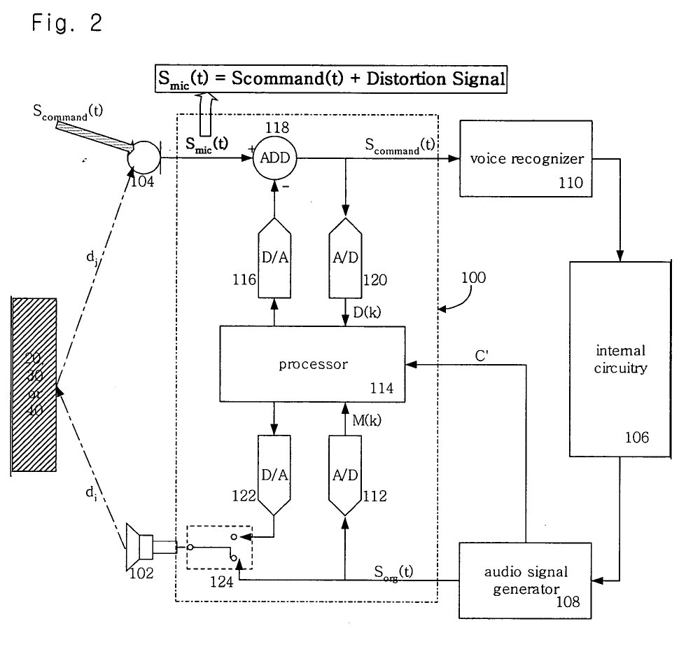

FIG. 2 shows a voice recognition system including a voice command identifier according to an embodiment of the present invention. As shown in FIG. 2, the voice command identifier 100 may be provided to a voice-producible system (simply called as a “system”, hereinafter), such as a television, a home or car audio player, a video player, etc., which can produce a sound output in itself. The voice-producible system having the voice command identifier 100 may include an internal circuitry 106 performing a predetermined function, an audio signal generator 108 for generating a sound signal S_{org}(t) of audio frequency based on a signal provided from the internal circuitry 106, a speaker 102 for outputting the sound signal as an audible sound, a microphone 104 for receiving external sound and converting them into an electrical signal S_{mic}(t), and a voice recognizer 110 for recognizing an object signal S_{command}(t) included in the electrical signal S_{mic}(t) from the microphone 104. The above described structure of the voice-producible system and its elements are known to an ordinary skilled person in the art of the present invention, so details of them are omitted for simplicity.

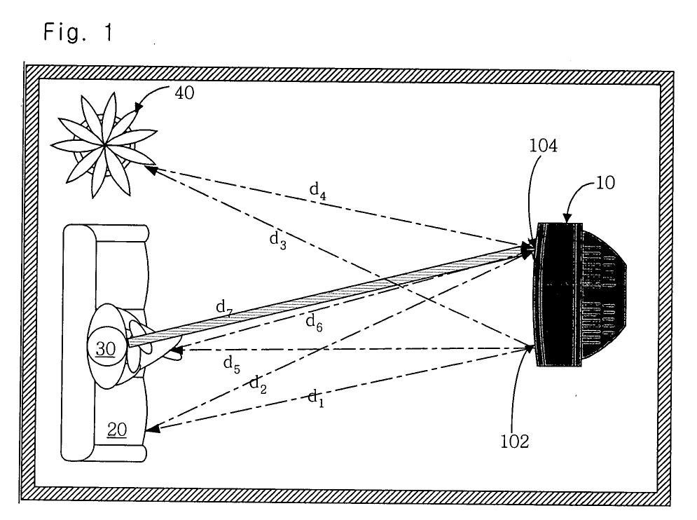

As described above about the conventional systems, the sound output by the system is re-input into the system by reflection or diffraction by various obstacles in the place where the system is located (see FIG. 1). Therefore, it is of very high probability that the voice recognizer 110 malfunctions because it can not distinguish a user's command from the re-input sound of the same or similar pronunciation, wherein the re-input sound is output by the system itself and reflected or diffracted by the environment.

The voice command identifier 100 identifies the user's voice command from the sound of the same or similar pronunciation included in the sound output by the system, and lets only the identified user's voice command to be input into the voice recognizer 110 of the system.

The voice command recognizer 100 according to an embodiment of the present invention includes a first analog-to-digital converter 112 for receiving the sound signal S_{org}(t) from the audio signal generator 108 and converting them into a digital signal, an adder 118 for receiving the electrical signal S_{mic}(t) from the microphone 104 and outputting an object signal S_{command}(t), which is to be recognized, and a second analog-to-digital converter 120 for receiving the object signal S_{command}(t) and converting them into a digital signal.

The first and second analog-to-digital converters 112 and 120 perform their operations in response to control of a microprocessor 114 provided to the voice command identifier 100 of the present invention. The microprocessor 114 performs required calculations and control operations for controlling operations of the above described elements 112, 118 and 120, besides. The microprocessor 114 is one of the general-purpose hardware and can be clearly defined by its operations described by this specification in detail. Other known details about microprocessors are omitted for simplicity.

The voice command identifier 100 may further include a memory (not shown) of a predetermined storing capacity. The memory may preferably be an internal memory of the microprocessor 114. Of course, an additional external memory (not shown) may be used for more sophisticated control and operation. Note that data converted into/from the sound signal is retrieved or stored from/into the memory according to control of the microprocessor 114. As for the type of the memory, it is preferable to use both volatile and nonvolatile types of memories, as described later.

The voice command identifier 100 further includes a first and second digital-to-analog converters 116 and 122 for converting retrieved data from the memory into an analog signal according to control of the microprocessor 114. The voice command identifier 100 further includes an output selecting switch 124 for selecting one of outputs out of the second digital-to-analog converter 122 and the audio signal generator 108 according to control of the microprocessor 114.

As shown in the drawing, the adder 118 performs subtraction operation of the output signal received from the first digital-to-analog converter 116 from the electrical signal S_{mic}(t) from the microphone 104.

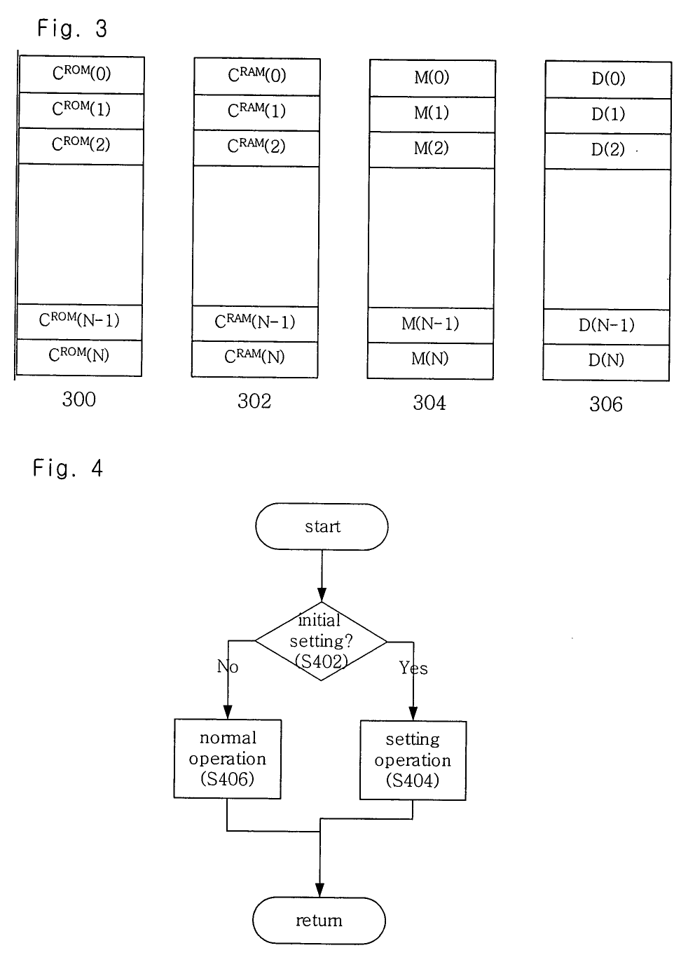

FIG. 3 shows a schematic diagram of a memory structure managed by the voice command identifier shown in FIG. 2. As shown in FIG. 3, the memory may be structured to have four (4) identifiable sub-memories 300, 302, 304 and 306. The first and second sub-memories 300 and 302 store data of a environmental coefficient C(k), which is digitized one corresponding to the environmental variable Aₖ in the Equation 1. The environmental coefficient C(k) reflects physical amount of attenuation and/or delay due to the environment in which the sound output by the speaker 102 is reflected and/or diffracted and re-input into the microphone 104. Therefore, as described later, even in case the sound signal S_{org}(t) output by the system is changed by the characteristic nature of the environment where the system is installed, the user's voice command, which should be the object of recognition, can be distinguished from re-input sound, which is output by the system itself, by acquiring the environmental coefficient C(k) through a setting procedure performed at the time of the first installation of the system at a specific environment.

It is preferable to use a nonvolatile memory as the first sub-memory 300 and a fast volatile memory as the second sub-memory 302. Therefore, the second sub-memory 302 may not be used in case processing speed is not important, or the first sub-memory 300 may not be used in case power consumption is not important.

The third sub-memory 304 sequentially stores digital signal M(k)'s, which is sequentially converted from the sound signal S_{org}(t) from the audio signal generator 108. The third sub-memory 304, as described later, does not replace a value acquired by the prior processing operation with new value acquired by the present processing operation at the same storage area. The third sub-memory 304 stores every and each value acquired by several processing operations during a predetermined period on a series of storage areas until a predetermined number of values are acquired, where the storage area is shifted by one value and another. (This storage operation of a memory is called as “Que operation”, hereinafter.) The Que operation of the third sub-memory 304 may be performed according to control of the microprocessor 114, or by a memory device (not shown) structured to perform the Que operation.

The fourth sub-memory 306 sequentially stores digital signals D(k) into which the signal S_{command}(t) (“object signal”) output by the adder 118 is converted by the second analog-to-digital converter 120. It is also preferable to use a fast volatile memory as the fourth sub-memory 306. The third sub-memory 304 is used for the normal operation, and the fourth sub-memory 306 is used for the setting operation, as described later. Thus, it is possible to embody the third and fourth sub-memories 304 and 306 by only one physical memory device.

It is enough to distinguish the first to fourth sub-memories 300, 302, 304 and 306 from one another logically, thus it is not always necessary to distinguish them from one another physically. Therefore, it is possible to embody the sub-memories with one physical memory device. This kind of structuring memory device is already know to an ordinary skilled person in the art of the present invention, and detailed description on that is omitted for simplicity.

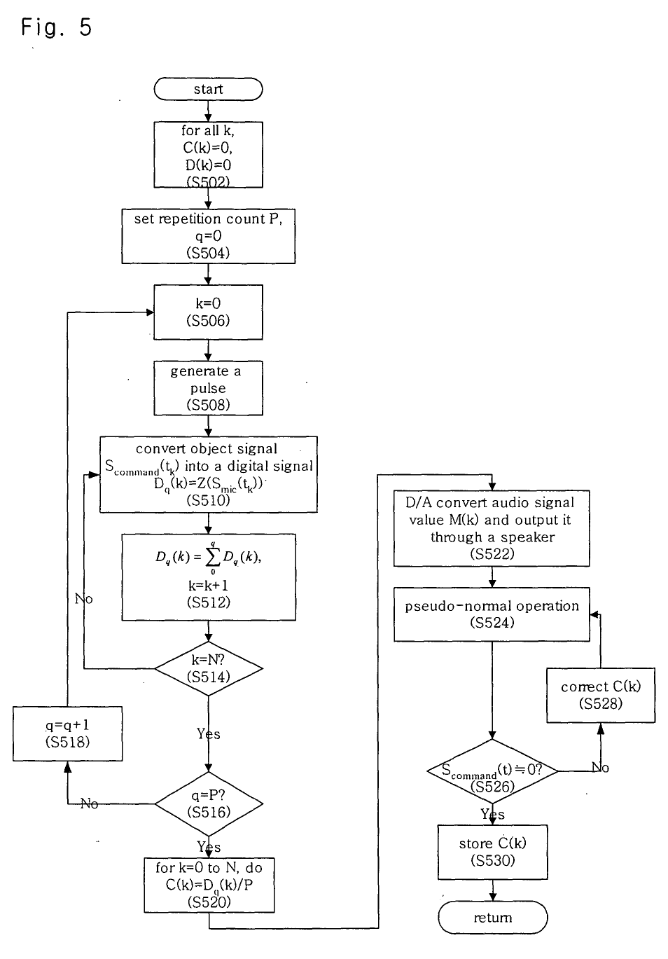

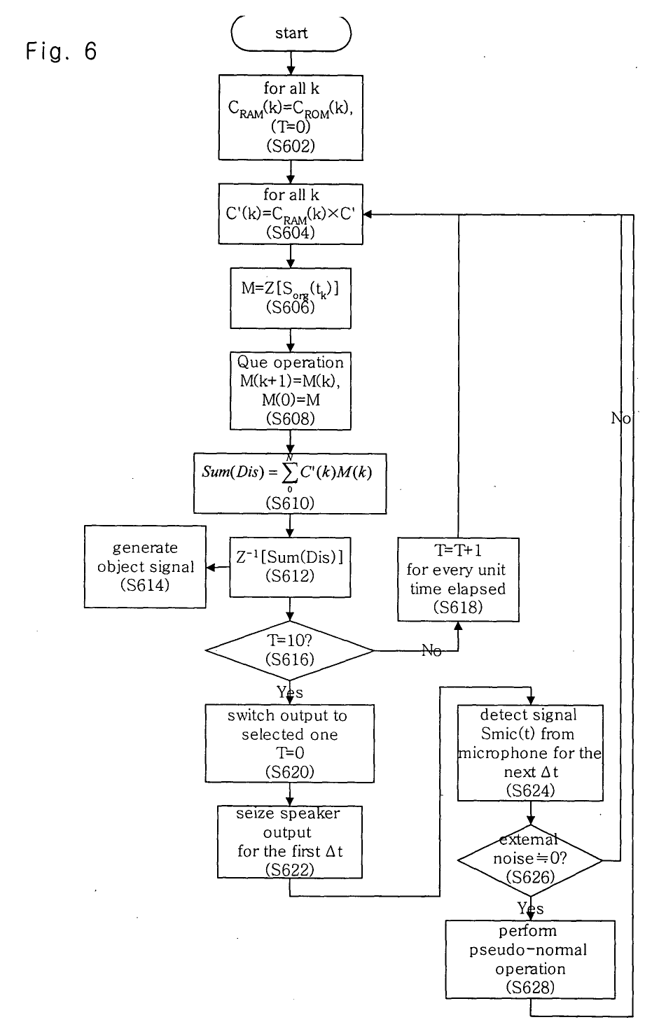

Now, referring to FIGS. 4 to 9, operation of the voice command identifier 100 is described in detail. FIG. 4 shows a flowchart of operation of the voice command identifier shown in FIG. 2 according to an embodiment of the present invention. When power is applied to the system and the operation is started, the voice command identifier 100 determines to perform a setting operation (step S402). It is preferable to perform the step S402 when the setting operation has never been performed or when the user wants to do it. Therefore, it is preferable to set the voice command identifier 100 to automatically perform a normal operation (refer to step S406), and to perform the setting operation (step S402) only when, for example, the user presses a predetermined button or a predetermined combination of buttons of the system. In other words, if the user orders to perform the setting operation, the voice command identifier 100 performs the setting operation shown in FIG. 5, and otherwise it performs the normal operation shown in FIG. 6.

FIG. 5 shows a flowchart of a “setting operation” shown in FIG. 4 according to an embodiment of the present invention. As described above, when the user ordered to perform the setting operation and the setting operation starts, each and every variable stored in the first to fourth sub-memories 300, 302, 304 and 306 is reset to have a predetermined value, for example zero (0), (step S502). Then, a total repetition count P of the setting operation, which shows how many times the setting operation will be performed for current trial, is set according to a user's preference or a predetermined default value. And, a current repetition count q of the setting operation, which shows how many times the setting operation has been performed for current trial, is initialized to a predetermined value, for example zero (q=0), (step S504). The total repetition count P of the step S504 may be set to a predetermined value during its manufacturing, or may be set by the user every time the setting operation is performed.

Next, a variable k is initialized (for example, k=0) (step S506). The variable k shows the order of a sampled value during a predetermined setting period Δt for digitizing an analog signal. The variable k has a value in the range of zero (0) to a predetermined maximum value N, which is dependent on the storage capacity of the memory device used, the processing performance of the microprocessor 114, required accuracy of voice command identification, etc.

Then, the microprocessor 114 controls the output selecting switch 124 to couple output of the speaker 102 to the second digital-to-analog converter 122, so that a sound signal data corresponding to a pulse δ(t) having amplitude of one (1) is generated during the setting period Δt, and a sound according to the sound signal data is output from the speaker 102 (step S508).

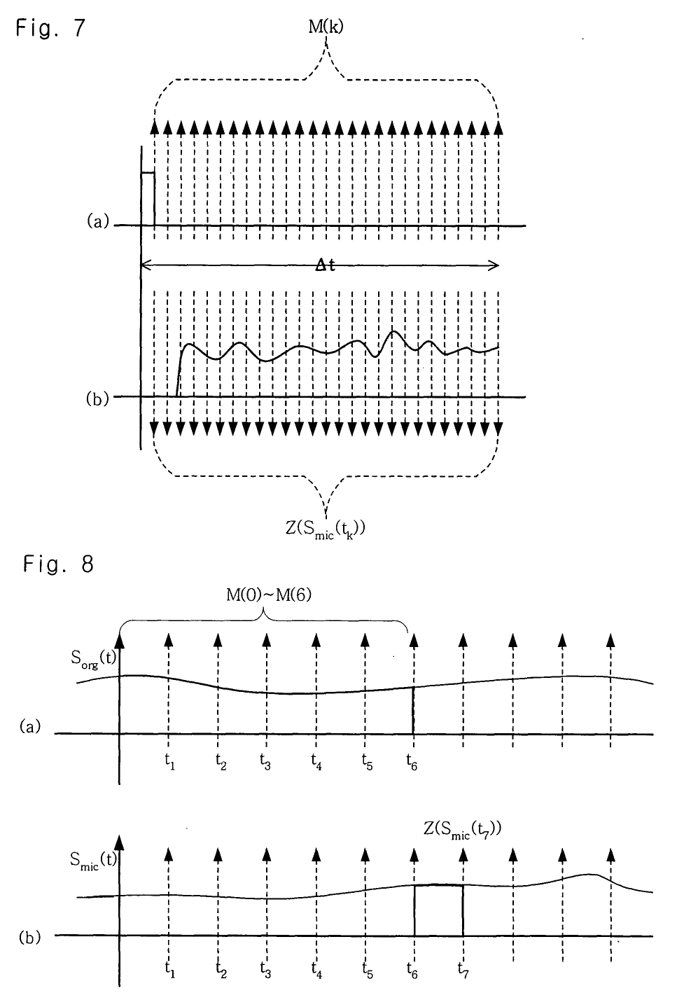

FIGS. 7a and 7b show waveforms of a pulse output during the step S508 and an electrical signal S_{mic}(t) generated by the microphone 104 receiving the pulse signal, respectively. As shown in the drawing, M(k) is defined to be a value of a digital signal, to which the pulse δ(t) is digitized, and then each M(k) has a value of one (1) during the setting period Δt. It is only because of the calculation simplicity to generate the pulse δ(t) as described above to have the amplitude of one (1), therefore it is also possible to generate the pulse δ(t) to have a value other than one (1) according to another embodiment. This embodiment is described later. Further, the setting period Δt is a very short period of time (i.e. several milliseconds) in practice, so there is no possibility for an audience to hear the sound resulted from the pulse δ(t).

Next, the second digital-to-analog converter 116 converts the object signal S_{command}(t) into digital signals, and stores the digital signals to the fourth sub-memory 306 (step S510). At this moment, while performing the current step, the first digital-to-analog converter 116 does not generate any signal. Therefore, the object signal S_{command}(t) is identical to the electrical signal S_{mic}(t) from the microphone. Further, the value of the variable D(k) is repeatedly acquired by performing the setting process P times, and the P values of the D(k)'s may be averaged. The subscript q shows the order of the acquired value of D(k). This is also true to other variables. Thus, in case the setting operation is performed only once, the subscript q has no meaning. Further, the operation of converting an analog signal into digital signals is represented as a function, Z[ ], in the drawing.

Next, a value of D(k) acquired during current setting operation is accumulated to that (or those) acquired during prior setting operation(s). Next, it is determined whether or not the variable k is equal to the maximum value N, and, if the result is negative, the above described steps S510 to S514 are repeated until k becomes equal to N.

Next, it is determined whether or not the subscript q is equal to the total repetition count P (step S516), and, if the result is negative, the subscript q is increased by a predetermined unit (step S518) and the above steps S506 to S516 are repeated.

After completing the above described steps, final values of variables D(k)'s are divided by the total repetition count P, and then the divided values are stored in the first sub-memory 306 as environmental coefficients C(k)'s, respectively. The environmental coefficient C(k) is based on the following Equation 2;

0=D(k)−C(k)*Z[δ(t)] [Equation 2]

Here, since Z[δ(t)] is a pulse of a value known to the microprocessor 114, it may be considered to have a value of one (1) by the second digital-to-analog converter 122. Thus, it is possible to say D(k)=C(k). Further, as described above, each value of D(k) acquired during each setting operation is accumulated to D(k) itself, and the final D(k) should be divided by the total repetition count P to get an averaged value of the D(k).

In case the pulse generated in the step S508 has a value A other than one (1), a value of P*A, P multiplied by A, is calculated. Then, the final value of each D(k) is divided by the value of P*A and the divided value of each D(k) is stored in the first sub-memory 306 as the environment coefficient C(k).

As described later, the C(k) is multiplied by the data M(k) digitized from a sound signal during a normal operation to become a sound source data for generating approximation signal Sum(Dis), which is an approximation of a noise signal S_{dis}(t) of the Equation 1.

Steps of the setting operation are performed as described above. According to another embodiment of the present invention, steps S522 to S530 may additionally be performed to acquire more precise calculations. This is described in detail, hereinafter.

After acquiring the environment coefficient C(k), the microprocessor 114 stores random data to the third sub-memory 304 as a temporary value of the variable M(k), which is then used to generate sound output through speaker 102 (step S522). Next, a “normal operation”, as described in detail later, is performed (step S524) to determine whether or not the object signal S_{command}(t) is substantially zero (0) (step S526). If the result of the determination of the step S526 is affirmative, the current environmental coefficient C(k) is stored (step S530) and the control is returned. If negative, the current environmental coefficient C(k) is corrected (step S528), and the steps S524 and S526 are repeated.

As described above, since the environmental coefficient C(k) may be corrected during the normal operation, the environmental coefficient C(k) having an initial value due to the initial environment may have new value due to changed environment. For example, if the system is a television, existence of an audience may require new value of the environmental coefficient C(k). Or, change of the number of audience(s) may be regarded as change of the environment, which make the reflection characteristics different. So, it may be required for the environmental coefficient C(k) to be corrected to have a new value corresponding to the new environment in this case, also.

It is preferable to store the environmental coefficient C(k) in a non-volatile memory, as described above. It is not required to re-acquire the environmental coefficient C(k) when the system power is off and on again with the non-volatile memory storing the environmental coefficient C(k) if the environment has not been changed. However, as described above, if the amount of power consumption is not important, a volatile memory may be used, but in this case the setting operation is performed after the system power is on again.

FIG. 6 shows a flowchart of the “normal operation” shown in FIG. 4 according to an embodiment of the present invention. As described above with reference to FIG. 4, it is preferable to automatically perform the normal operation (step S406) if the setting operation (step S404) is not performed.

Now, referring FIG. 6 again, after the operation starts, the microprocessor 114 loads the environmental coefficient C(k) to the fast second sub-memory 302 from the slow first sub-memory 300, and the loaded environmental coefficient C(k) in the second sub-memory 302 is designated as “C^{RAM}(k)” (step S602). At this moment, the clocking variable T may be initialized (i.e. T=0), which is described later.

Next, the microprocessor 114 receives volume data C' from the audio signal generator 108, multiplies the environmental coefficient C^{RAM}(k) loaded to the second sub-memory 302 by the volume data C' to acquire weighted environmental coefficient C'(k) (step S604).

Next, the sound signal S_{org}(t) from the audio signal generator 108 is converted into digital data M during a predetermined sampling period (step S606). The converted digital data M is stored in the third sub-memory 304 as data M(k) by Que operation (step S608). The steps S606 and S608 are repeated during the sampling period, and every converted digital data at each sampling time point tₖ is stored in the third sub-memory 304 as the data M(k).

Next, a pseudo-distortion signal Sum(Dis) is calculated using the M(k) in the third sub-memory 304 and the weighted environment coefficient C'(k) according to the following Equation 3 (step S610).

$$Sum ( Dis ) = {\sum }_{k = 0}^{N} {C}^{′} ( k ) M ( k ) \qquad [ Equation 3 ]$$

Here, N is an upper limit, which is based on an assumption that the sampling period and the sampling frequency are equal to those used for the setting operation.

Now, with reference to FIG. 8, the physical meaning of the pseudo-distortion signal Sum(Dis) is described in detail. FIG. 8 shows waveforms of the sound signal S_{org}(t) output from the audio signal generator 108 during the normal operation and the electrical signal S_{mic}(t) received and generated from the microphone 104. If the sampling period is from to t₀ t₆ and the present time point is t₇, various sound signals, which are output from the speaker 102 from to t₀ t₇ and distorted by various environmental variables via various paths (i.e. paths d₁ to d₆ as shown in FIG. 1), are superposed and input to the microphone 104. Thus, the electrical signal S_{mic}(t₇) generated by the microphone 104 at the present time point t₇ includes superposed signals of the user's command signal and the distorted signals. Since the superposed signals of the distorted signals reflect cumulative effects of the environmental variables, the pseudo-distorted signals Sum(Dis)ₜ₌₇ at the present time point t₇ may be represented as the following Equation 4;

$$\begin{matrix}{Sum ( Dis )}_{t = 7} = {\sum }_{k = 0}^{6} {C}^{′} ( k ) M ( k ) \\ = [ {C}^{′} ( 0 ) M ( 0 ) + {C}^{′} ( 1 ) M ( 1 ) + \\ {C}^{′} ( 2 ) M ( 2 ) + {C}^{′} ( 3 ) M ( 3 ) + \\ {C}^{′} ( 4 ) M ( 4 ) + {C}^{′} ( 5 ) M ( 5 ) + {C}^{′} ( 6 ) M ( 6 ) ]\end{matrix} \qquad [ Equation 4 ]$$

Next, the first digital-to-analog converter 116 converts the pseudo-distortion signal Sum(Dis) into an analog signal (step S612), and the adder 118 subtracts the converted pseudo-distortion signal from the electrical signal S_{mic}(t) to generate the object signal S_{command}(t) which is to be recognized by the voice recognizer 110 (step S614).

By performing the above described steps, the possibility for the voice recognizer 110 to perform false recognition is substantially decreased to zero (0) even though the sound output from the speaker 102 includes sounds similar to voice commands, which may be recognized by the voice recognizer 110, because the pseudo-distortion signal Sum(Dis) corresponding to the sounds similar to voice commands is subtracted from the signals input to the microphone 104.

The normal operation of the voice command identifier 100 according to an embodiment of the present invention is completed by completing the above steps. However, even during the above described normal operation, the environment may be change from one during the setting operation by a user's movement or entrance of a new audience. Therefore, it may be preferable to perform the above described steps S 502 to S520 of the setting operation shown in FIG. 5 during the normal operation at an every predetermined time. In this case, steps S616 to S628 as shown in FIG. 6 may be additionally performed, as described hereinafter.

It is determined whether or not the clocking variable T initialized in the step S602 becomes to be equal to a predetermined clocking value (i.e. 10) (step S616). The clocking variable T is used to indicate elapsed time for performing the normal operation of steps S602 to S614, and may easily be embodied by system clock in practice. Further, the predetermined clocking value is set to perform the setting operation at an every predetermined time, for example 10 seconds, and may be set by a manufacturer or a user.

If the determination result of the step S616 shows that the current value of the clocking variable T is not yet equal to the predetermined clocking value, the value of the clocking variable is increased by a unit value (i.e. one(1)) as a unit time (i.e. one (1) second) has elapsed (step S618), and the normal operation of the steps S604 to S616.

However, if the determination result of the step S616 shows that the current value of the clocking value T is equal to the predetermined clocking value, the microprocessor 114 controls the output selecting switch 124 to select the second digital-to-analog converter 122 and to couple it to the speaker 102, and to initialize the value of the clocking variable T (i.e. T=0), again.

Next, the microprocessor 144 controls the speaker 102 not to generate any sound (step S622). This is to wait until remaining noise around the system disappears.

Next, after a predetermined time period for waiting for the noise to disappear, the microprocessor 144 detects the electrical signal S_{mic}(t) from the microphone 104 for another predetermined time period (step S624), and determines whether or not any noise is included in the detected electrical signal S_{mic}(t) (step S626). By doing this, it is possible to determine whether or not external noise is input into the microphone 104 because it is difficult to acquire normal environmental coefficient C(k) under the presence of the external noise. In case the determination result of the step S626 shows that external noise is detected, the present setting operation may be canceled to return control to the step S604, and the normal operation is continued.

However, if the external noise is not detected, the setting operation of steps S502 to S520 is performed (step S628).

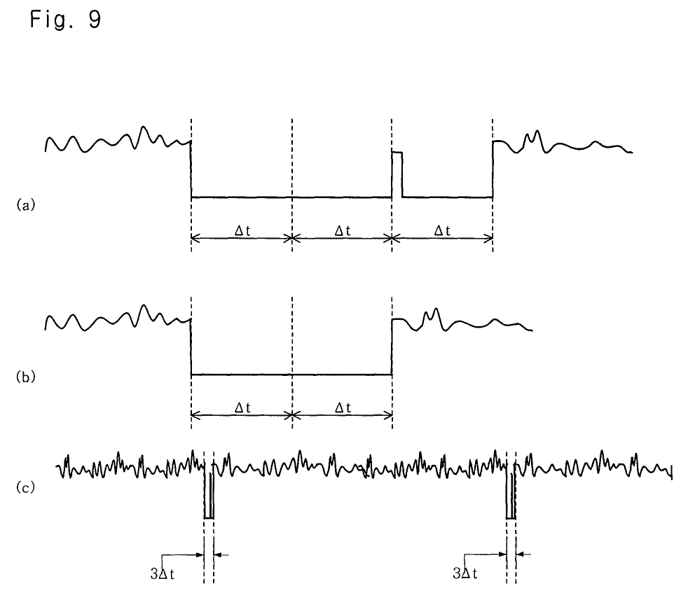

FIGS. 9a and 9b respectively show waveforms of an output signal output from the speaker 102 when the renewal setting operation (steps S616 to S628) during the normal operation is performed and one output when it is not performed. As shown in the drawings, it is preferable that the step S622 is started during the first Δt period and maintained for the second Δt period, the steps S624 and S626 are performed during the second Δt period, and the step S628 is performed during the third Δt period. Of course, actual duration of the Δt period may be adjusted according to the embodiments.

FIG. 9c shows a waveform of an output signal output from the speaker 102 while the waveform shown in FIG. 9a is output two (2) times. As shown in the drawing, actual duration of the time period, or 3Δt, for performing the renewal setting operation is very short (i.e. several milliseconds), so the user can not notice the performance of the renewal setting operation.

According to one embodiment of the present invention, it is possible to identify a user's voice command from sound signals reflected and re-input and to allow a credible voice recognition in a system having its own sound source. Further, it is also possible to achieve a real time voice recognition due to substantial reduction of amount of calculation.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A voice command identifier for a voice-producible system having an internal circuitry, a speaker that outputs an audible sound signal, and a microphone that receives an external sound signal and converts the received sound signal into an electrical signal, the voice command identifier comprising:
a first analog-to-digital converter configured to receive a sound signal and convert the received sound signal into a first digital signal;
an adder configured to receive an electrical signal from the microphone and output an object signal;
a second analog-to-digital converter configured to receive the object signal and convert the received object signal into a second digital signal;
a memory;
first and second digital-to-analog converters configured to convert retrieved data from the memory into analog signals; and
an output selecting switch configured to select one of the analog signals output from the second digital-to-analog converter and the sound signal so as to provide the selected output to the speaker.

2. A voice command identifier as claimed in claim 1, further comprising a microprocessor configured to control operations of the memory, the first analog-to-digital converter, the adder, the first and second digital-to-analog converters, and the output selecting switch.

3. A voice command identifier as claimed in claim 1, wherein the adder is configured to receive the analog signal from the first digital-to-analog converter and subtract the output signal from the electrical signal output from the microphone.

4. A voice command identifier as claimed in claim 1, wherein the memory comprises a plurality of sub-memories which are identifiable from one another, and
wherein the sub-memories comprise:
a first sub-memory configured to store an environmental coefficient uniquely determined by an environment of the voice-producible system; and
a second sub-memory configured to store at least one of the first digital signal and the second digital signal.

5. A voice command identifier claimed in claim 4, wherein the environmental coefficient is acquired by digitizing a signal input into the microphone for a predetermined time period after a pulse of a predetermined amplitude and width output from the speaker.

6. A voice command identifier claimed in claim 4, wherein the object signal is acquired by multiplying the first digital signal with the environment coefficient, accumulating a multiplied result for a predetermined time period, converting the accumulated result into an analog signal and subtracting the analog signal from the electrical signal output from the microphone.

7. A voice command identifying method for a voice-producible system having an internal circuitry, a speaker that outputs an audible sound signal, and a microphone that receives an external sound signal and converts the received sound signal into an electrical signal, the method comprising:
(a) determining whether a setting operation or a normal operation is to be performed;
in case the determination result of (a) shows that the setting operation is to be performed,
(a-1) outputting a pulse of a predetermined amplitude and width; and
(a-2) acquiring an environmental coefficient, uniquely determined by the operational environment of the voice-producible system, by digitizing a signal input into the microphone for a predetermined time period after the pulse is output.

8. A voice command identifying method as claimed in claim 7, wherein in case the determination result of (a) shows that the normal operation is to be performed, the method further comprises:
(b-1) analog-to-digital converting a signal output from an audio signal generator so as to acquire a digital signal, wherein the audio signal generator generates a sound signal of audio frequency based on a signal received from the internal circuitry;
(b-2) multiplying the digital signal acquired by (b-1) with the environmental coefficient and accumulating a multiplied result; and
(b-3) digital-to-analog converting the accumulated result into an analog signal and generating an object signal by subtracting the analog signal from the electrical signal output from the microphone, wherein the object signal is recognized by a voice recognizer of the voice-producible system.

9. A voice command identifying method as claimed in claim 8, wherein in case the determination result of (a) shows that the setting operation is to be performed, the method further comprises:
(a-3) outputting a sound signal from the audio signal generator through the speaker; and
(a-4) performing (b-1) to (b-3).

10. A voice command identifying method as claimed in claim 8, wherein in case the determination result of (a) shows that the normal operation is to be performed, the method further comprises:
(b-4) controlling the speaker to be muted;
(b-5) determining whether or not a signal is input into the microphone; and
(b-6) in case the determination result of (b-5) shows that no signal is input into the microphone, performing (a-1) and (a-2).

11. A voice command identifying method for a voice-producible system having an internal circuitry, a speaker for outputting an audible sound signal, a microphone for receiving an external sound signal and converting the received sound signal into an electrical signal, the method comprising:
(a) determining whether a setting operation or a normal operation is to be performed;
in case the determination result of (a) shows that the setting operation is to be performed,
(a-1) initializing all variables;
(a-2) setting a total repetition count P showing a total number of repeated performance of a setting operation, and initializing a variable of current repetition count q, which is indicative of the number of repeated performances of the setting operation;
(a-3) initializing a variable k, which is indicative of the order of a sampled value during a predetermined setting period;
(a-4) generating a sound signal data corresponding to a pulse of a predetermined amplitude and width during the predetermined setting period and outputting the sound signal through the speaker;
(a-5) converting an object signal into a digital signal, wherein the object signal is included in the electrical signal output from the microphone and is recognized;
(a-6) accumulating the value of the digital signal converted in (a-5);
(a-7) determining whether or not the current repetition count q is equal to the total repetition count P, and, if not, performing (a-3) to (a-6) again; and
(a-8) acquiring an environmental coefficient uniquely determined based on an environment of the voice-producible system by dividing the accumulated value by the total repetition count P.

12. A voice command identifying method as claimed in claim 11, wherein in case the determination result of (a) shows that the normal operation is to be performed, the method further comprises:
(b-1) loading the environmental coefficient;
(b-2) receiving volume data from an audio signal generator, and acquiring a weighted environmental coefficient by multiplying the volume data with the environmental coefficient, wherein the audio signal generator is configured to generate a sound signal of audio frequency based on a signal provided from the internal circuitry;
(b-3) converting a sound signal from the audio signal generator into a digital signal during a predetermined sampling period;
(b-4) storing the digital signal converted in (b-3) into a memory by Que operation;
(b-5) acquiring a pseudo-distortion signal Sum(Dis) using the data stored in the memory and the weighted environmental coefficient according to the following equation:
$$Sum ( Dis ) = {\sum }_{k = 0}^{N} {C}^{′} ( k ) M ( k )$$
(b-6) converting the pseudo-distortion signal Sum(Dis) into an analog signal; and
(b-7) generating the object signal by subtracting the analog pseudo-distortion signal from the electrical signal from the microphone.

13. A voice command identifying method as claimed in claim 12, wherein
in case the determination result of (a) shows that the setting operation is to be performed, the method further comprises:
(a-9) outputting a sound signal due to a random data through the speaker;
(a-10) performing (b-1) to (b-7)
(a-11) determining whether or not the object signal is substantially zero (0); and
(a-12) if the determining result of (a-11) is affirmative, keeping the environmental coefficient as before, and if the determining result of (a-11) is negative, correcting the environmental coefficient and performing (a-9) to (a-11).

14. A voice command identifying method as claimed in claim 12, wherein in case the determination result of (a) shows that the normal operation is to be performed, the method further comprises:
(b-8) determining whether or not it is the time indicated by a predetermined clocking variable T;
(b-9) if the determination result of (b-8) is negative, performing (b-1) to (b-7) repeatedly;
(b-10) if the determination result of (b-8) is positive, controlling the speaker not to generate any sound;
(b-11) determining whether or not a signal is input into the microphone by detecting the electrical signal from the microphone for a predetermined time period;
(b-12) in case the determination result of (b-11) shows that a signal is input into the microphone, performing (b-1) to (b-7); and
(b-13) in case the determination result of (b-11) shows that no signal is input into the microphone, performing (a-1) and (a-8).

15. A voice command identifier as claimed in claim 1, further comprising an audio signal generator configured to generate the sound signal based on a signal received from the internal circuitry; and
a voice recognizer configured to recognize the object signal included in the electrical signal output from the microphone.
